(19) United States
(12) Patent Application Publication
(10) Pub. No.: US 2012/0329004 A1
(43) Pub. Date: Dec. 27, 2012

(54) ARTICULATOR

(76) Inventors: Chae Bung Lee, Gyeongju-si (KR); Se Hun Kim, Jeonju-si (KR)

(21) Appl. No.: 13/582,988

(22) PCT Filed: Apr. 16, 2010
(86) PCT No.: PCT/KR2010/002401

§ 371 Date: Sep. 5, 2012

(30) Foreign Application Priority Data
Mar. 5, 2010 (KR) 10-2010-0019933

(51) Int. Cl. A61C 11/00

(52) U.S. Cl. 433/54

(57) ABSTRACT

The present invention relates to an articulator used for the purpose of checking the alignment of dentures, by coupling together models of the upper and lower jaws, in order to provide a simple movement of the upper and lower jaws, minimize occlusal errors, and accurately mount the upper and lower jaws on the occlusion surface. Conventional articulators imitate the form of upper and lower jaw movements, wherein a reference axis is established and folded in accordance with a condyle, however, the process completely eliminates muscle movement, and inevitably leads to occlusal errors of the upper and lower jaw movement. Consequently, the problem with conventional articulators is the need for post-processing, regardless of the extent of reduction of the occlusal errors through the use of diverse assisting means. In addition, while accurate occlusion cannot be achieved, conventional articulators have a structure that is too complicated and difficult to operate. Therefore, in a non-arcon type articulator, a reference axis is formed on a line extending from the central plane of an upper jaw mounting plate and a lower jaw mounting plate, so that the tangent of rotation creates a vertical motion on the occlusion surface, which allows upward and downward movements that are closer to physiological movements than conventional assisting means, which require making fine adjustments to occlusion, minimizes the margin of error of the articulator, and provides a simple operating structure for the upper and the lower jaw mounting plates and an easier usage thereof.

### TECHNICAL FIELD

The present invention relates to an articulator which makes it possible to check an arranging relationship of teeth in such a way to attach upper and lower law models, and particularly to an articulator which makes it possible to minimize an articulating error and to mount accurately an upper jaw and a lower jaw on an articulating surface while ensuring a simple motion structure of an upper jaw and a lower jaw.

### BACKGROUND ART

An articulator is a device generally used for the sake of a manufacture and diagnosis of denture, tooth crown restoration, prosthetic appliance, etc. by measuring a coupled state of teeth and a gum and is configured to mechanically imitate and reproduce a relative position relationship of a jawbone and teeth with respect to a cranium and the motions of a lower jaw.

The upper and lower jaw motions of a human being's body come as a lower jaw bone moves with an upper jaw bone not moving, so most of the articulators are designed imitating the motions of the upper and lower jaw bones. A reference axis where an upper jaw mounting plate and a lower jaw mounting plate are folded is formed about a condylar.

In addition, a folding structure of an articulator is classified into an arcon condylar type articulator in which an over load guide part is positioned at the side of an upper jaw depending on the position of a condylar element, and a non-arcon condylar articulator in which an over load guide part remains at the side of a lower jaw. In case of the non-arcon condylar, since it is directed to a structure of a non-adjustable articulator which is focused on the reproduction of a lower jaw motion, it is widely used.

The above described articulator has a problems that in order for the tooth model to be most similar to the structures of the upper and lower jaws of a human being's body, as shown in FIGS. 16 and 17, it is manufactured so that the position of a reference axis is matched with the condylar in a structure which can reproduce the lower jaw motion of a human beings body; however when considering it based on a human being's anatomy, since the condylar is formed in a spherical shape, there is a lot of differences from the operation principles of the shaft. In addition, the upward and downward motions of the teeth are performed in a combination of the condylar and the muscle (masticatory muscle) motion. When considering only the position of the condylar as a reference axis, since the motions of the muscles are eliminated from considerations, errors inevitably occur when measuring the motions of upper and lower jaws.

In addition, there might be provided various adjusting means at the articulator for the purpose of adjusting error ranges in small ranges; however in case of the non-adjustable articulator, it is possible to measure only a simple opening and closing articulation because there is not provided a means for adjusting errors, so a proper method is not disclosed for correcting the errors.

The errors occur a lot when measuring the articulation, so a post-process is inevitably needed in a state that a patient has a prosthetic appliance.

The conventional articulator is characterized in that upper and lower jaw models are fixed while checking the positions of the articulating plane surface by using an auxiliary means such as a rubber string or a laser so as to position accurately the upper jaw and lower jaw models on the articulating plane surface. A lot of difficulties are needed when mounting accurately them using the above mentioned means, and minor errors occur owing to the thickness of the auxiliary means.

### DISCLOSURE OF INVENTION

Accordingly, the present invention is provided to overcome the above described problems and it is an object of the present invention to provide an articulator which makes it possible to minimize the error ranges of an articulator in such a way to set the position with a reference axis which is the center of a biological articulation during the motions of upper and lower jaws, and the structures of the upper jaw mounting plate and the lower jaw mounting plate of the articulator is simplified, so manufacture is easy, and the accurate articulation is made by accurately position the upper and lower models on the articulating plane surface.

To achieve the above objects, a reference axis is formed on an extension line of the articulating plane surface on which the upper jaw mounting plate and the lower jaw mounting plate are folded, and the rotary shaft of the upper jaw mounting plate is fixed at a non-arcon type engaging part of the lower jaw mounting plate.

A jig is configured to be detachable from the non-arcon type engaging part of the lower jaw mounting plate for the purpose of adjusting a horizontal state of the lower jaw model in the same type as the upper mounting plate, so that the upper and lower jaw models can be accurately positioned on the articulating plane surface.

### ADVANTAGEOUS EFFECTS

The present invention makes it possible to minimize the error ranges of the articulator by defining as a reference axis the point which is the center of the biological articulation of teeth, which results in an accurate articulation, and the construction of such articulator is simplified, and the manufacture of it is easy, and the manufacture cost is low.

In addition, since the position of the articulating plane surface can be set using the jig, the error range of the articulating can be more reduced.

### BRIEF DESCRIPTION OF DRAWINGS

FIG. 1 is a perspective view illustrating an embodiment of the present invention.

FIG. 2 is a side view illustrating a folding structure of an articulator according to the present invention.

FIG. 3 is a schematic view illustrating a biological articulating state of an articulator according to the present invention.

FIG. 4 is a perspective view illustrating a detaching structure of a lower jaw mounting plate and an upper jaw mounting plate of the present invention.

FIG. 5 is a side cross sectional view illustrating a detaching structure of a lower jaw mounting plate and an upper jaw mounting plate according to the present invention.

FIG. 6 is a side view of another embodiment of the engaging part of the present invention.

FIG. 7 is a plane cross sectional view illustrating a distorted state of a rotary shaft and an engaging part according to the present invention.

FIG. 8 is a perspective view illustrating a state that a jig is coupled to a lower jaw mounting plate according to the present invention.

FIG. 9 is a perspective view illustrating a state that a lower jaw mounting plate and a jig are coupled according to the present invention.

FIGS. 10 and 11 are schematic views illustrating a use state of a jig of FIG. 9.

FIG. 12 is a perspective view illustrating another embodiment of a jig of the present invention.

FIGS. 13 to 15 are schematic views illustrating a mounting procedure of upper and lower jaw models.

FIG. 16 is a side view illustrating a folding structure of a conventional articulator.

FIG. 17 is a schematic view illustrating the position of a reference axis of a conventional articulator.

### BEST MODES FOR CARRYING OUT THE INVENTION

The articulator comprises a lower jaw mounting plate 10 configured to mount a lower jaw model 100; an upper jaw mounting plate 20 configured to mount an upper jaw model 200; and an engaging part 11 and a rotary shaft 21 which are formed at the lower jaw mounting plate 10 and the upper jaw mounting plate 20, respectively, and are axially engaged, and columns 12 and 22 formed at the rear sides of the lower jaw mounting plate 10 and the upper jaw mounting plate 20 have the same vertical heights, and as the rotary shaft 21 is positioned on an extended line of the articulating plane surface (α), so the lower jaw mounting plate 10 and the upper jaw mounting plate 20 are symmetrically positioned upward and downward about the rotary shaft 21, and when the upper jaw model 200 and the lower jaw mode 100 are folded upward and downward, the tangent line (β) of the rotational motion is vertically applied to the articulating plane surface.

### MODES FOR CARRYING OUT THE INVENTION

Hereinafter the preferred embodiments of the present invention will be described with reference to the accompanying drawings. The same elements are assigned the same reference numerals in the drawings.

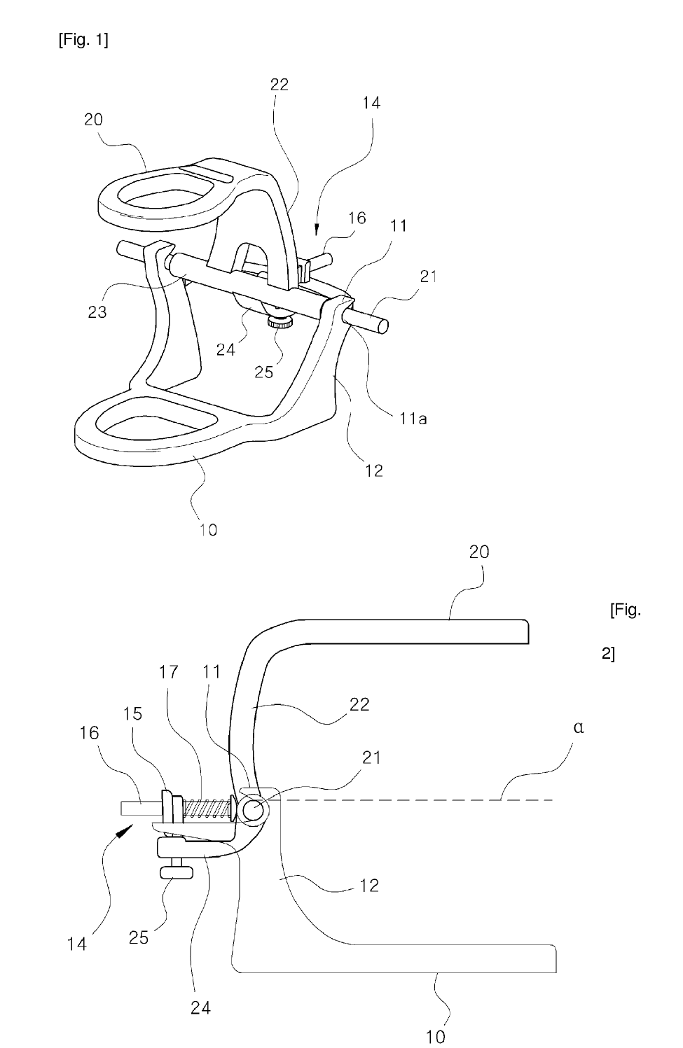

As shown in FIGS. 1 and 2, the present invention comprises a lower jaw mounting plate 10 and an upper jaw mounting plate 20, which are folded downward and upward by means of a rotary shaft 21 of an upper jaw mounting plate 20, and the articulating plane surface (α) is adjusted by adjusting the horizontality of the upper jaw mounting plate 20, and the lower jaw model 100 and the upper jaw model 200 are mounted on the thusly set articulating plane surface (α) for thereby checking the arranged relationship of the teeth.

At this time, the lower jaw model 100 and the upper jaw model 200 are mounted on the lower jaw mounting plate 10 and the upper jaw mounting plate 20, respectively, and the lower and upper jaw models 100 and 200 are fixed with a plaster.

At the rear sides of the lower jaw mounting plate 10 and the upper jaw mounting plate 20 are disposed the engaging part 11 and the rotary shaft 21, and they are axially engaged. The engaging part 11 and the rotary shaft 21 are configured so that the columns 12 and 22 formed at the rear side of the lower jaw mounting plate 10 and the upper jaw mounting plate 20 can have the same heights, whereby the engaging position of the rotary shaft 21 is positioned at the central heights of the lower jaw mounting plate 10 and the upper jaw mounting plate 20.

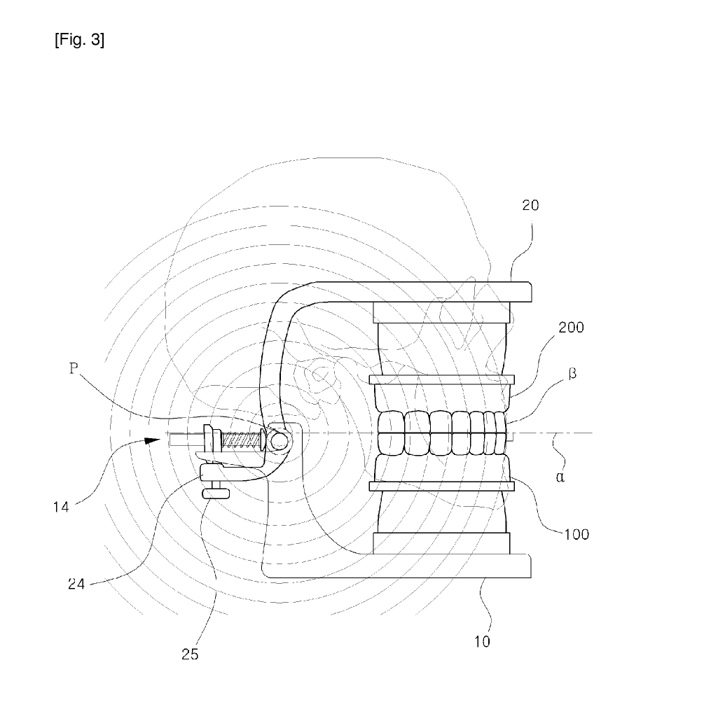

The rotary shaft 11 is positioned on an extension line of the articulating plane surface (α), and the lower jaw mounting plate 10 and the upper jaw mounting plate 20 operate symmetrically downward and upward, and as shown in FIG. 3, the tangent line (β) of the rotation motion of the upper jaw model 100 and the lower jaw model 200 comes into contact with the articulating plane surface (α) in a vertical direction, so they can be folded upward and downward about the point P where becomes the center of the biological articulation of the teeth.

The upper jaw model 100 and the lower jaw model 200 are folded upward and downward about the reference point P of the rear side, so the motion structure of the upper jaw and the lower jaw operates vertically closer to the biological teeth motions, so the error ranges of the articulator can be minimized, and more accurate articulation is possible.

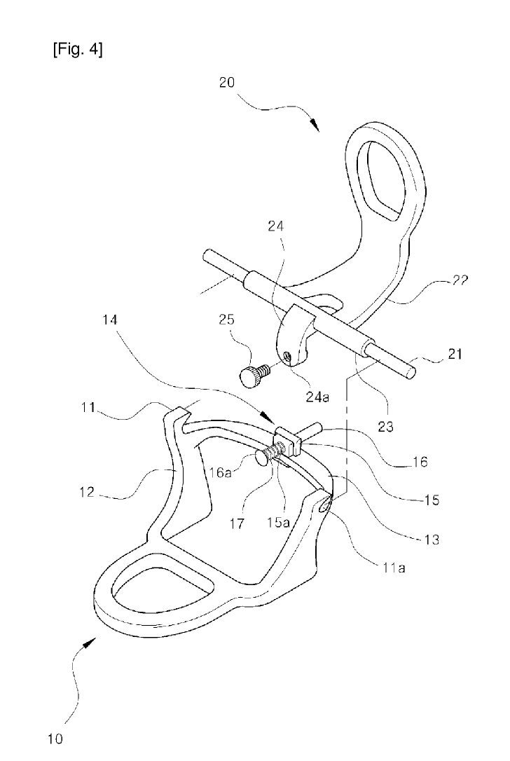

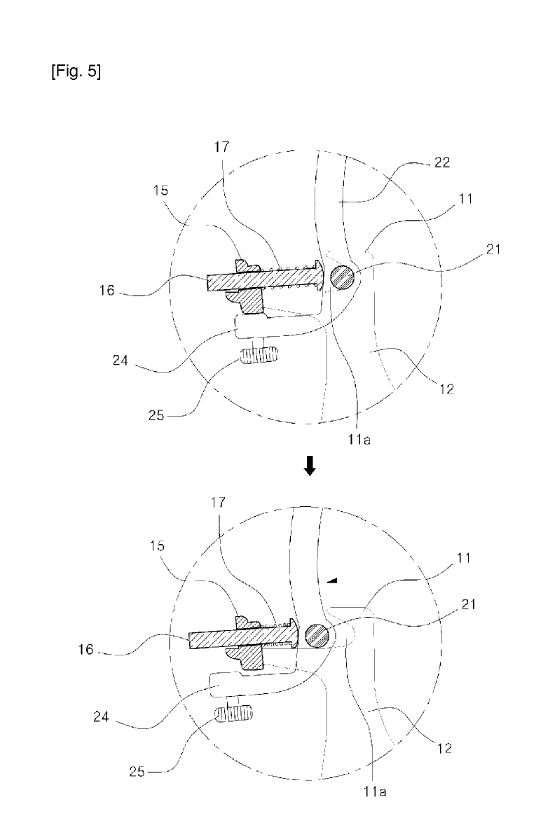

The structure that the lower jaw mounting plate 10 and the upper jaw mounting plate 20 are folded will be described with reference to the engaging structure of FIG. 4. The low jaw mounting plate 10 is formed in a laid-down channel shape at the top of the column 12 and has an inner insertion groove 11a which is open in the backward direction, and the upper jaw mounting plate 20 has a shaft 23 at a lower side of the column 22 formed at the rear side, and a rotary shaft 21 is protruded from both sides, and the rotary shaft 21 is axially engaged to the inner insertion groove 11a of the lower jaw mounting plate 10, so that the upper jaw mounting plate 20 can be folded upward and downward.

The lower jaw mounting plate 10 has a suspension part 13 connecting the tops of the columns 12 of left and right sides, and a support means 14 is formed at the top of the suspension part 13, so it is possible to prevent the upper jaw mounting plate 20 from disconnecting from the engaged state. The support means 14 is formed in an operational structure which is elastic in forward and backward directions, which helps detach the upper jaw mounting plate 20 in one touch way.

For the sake of that, a protrusion wall 15 is formed on an upper side of the suspension part 13, and a pusher 16 is inserted into a through hole 15a formed at the protrusion wall 15, and a compression spring is disposed between the head 16a of the pusher 16 and the protrusion wall 15, so the pusher 16 operates elastically and is fixed while elastically supporting the upper jaw mounting plate 20.

At this time, when it is needed to separate the upper jaw mounting plate 20, the lower jaw mounting plate 10 is held, and the upper jaw mounting plate 20 is pushed backward, and the pusher 16 is pushed backward, and the rotary shaft 21 of the upper jaw mounting plate 20 escapes from the engaging part 11, so the upper jaw mounting plate 20 can be discharged upward.

When the lower jaw model 100 and the upper jaw model 200 are mounted and eliminated, it can easily be done after the upper jaw mounting plate 20 is separated, so the mounting work can be down easily, and the work time can be reduced.

At this time, in the shaft 23, a hook protrusion 24 is formed and extended in a backward direction, and the top of the hook protrusion 24 is caught on the suspension part 13, thus limiting the slope of the upper jaw mounting plate 20, and at this time a screw hole 24a is formed at the hook protrusion 24, and when the bolt 25 is tightened, the spaced-apart space between the suspension part 13 and the hook protrusion 24 can be adjusted depending on the tightening state of the bolt 25, so the limiting angle of the upper jaw mounting plate 20 can be accurately set.

The articulator according to the present invention is characterized in that the arranged state of the teeth can be checked by distorting left and right the lower jaw model 100 and the upper jaw model 200 after an articulating sheet is inserted into between the models when it is needed to check the coupled state of the upper and lower jaw models 100 and 200. As explained above, since the engaging part 11 is formed in a laid-down channel shape, the backward disconnection of the rotary shaft 21 is made possible, so the lower jaw mounting plate 10 and the upper jaw mounting plate 20 can be distorted left and right from the state that they are pressurized forward by means of the support means 14.

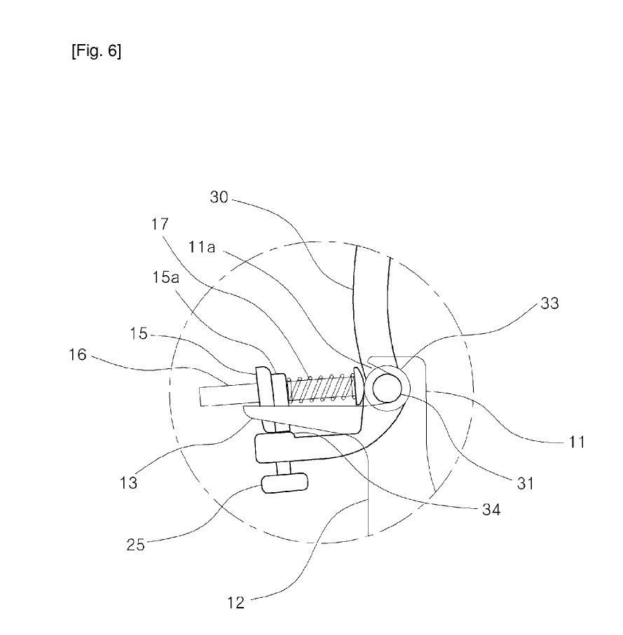

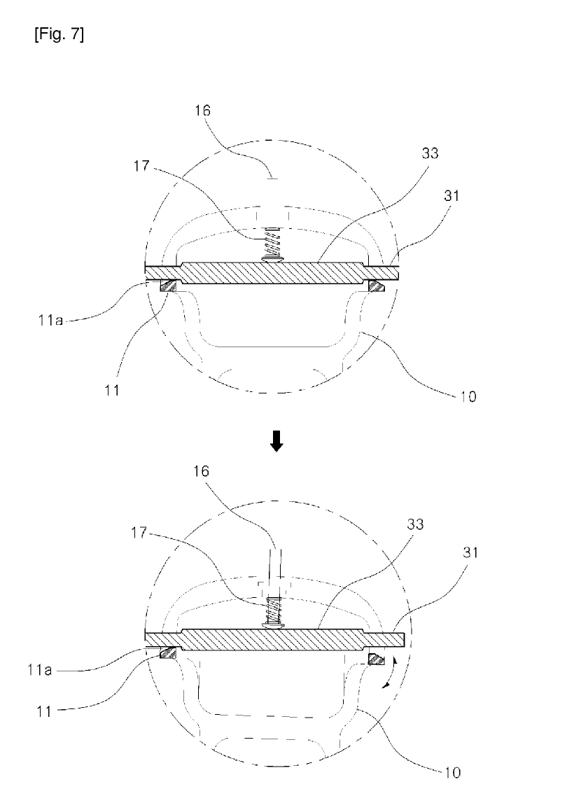

At this time, the engaging part 11 is characterized in that the inner insertion groove 11a is obliquely formed in an outward direction, and when distorting left and right the upper jaw mounting plate 20, the rotary shaft 21 is not interfered with an outer side shoulder, so the left and right distortions can be performed smoothly. At this time, the inner insertion groove 11a is formed to have a slope angle of −2° in a backwardly sagged shape as shown in FIG. 6, when the upper jaw mounting plate 20 is distorted left and right, the motions becomes closer to the biological articulation of the teeth, so the articulating measurement can be more accurately performed.

At this time, the reason that the slope angle is set at an angle of −2° lies in that the angle of the line connecting the point (P) which is the center of the biological articulation and the upper end portion of the front teeth is −2° from the virtual line, which is defined as a reference line, connecting the point (P) which is the center of the biological articulation in terms of human being's anatomical views and the cutting tooth point, so to match with the above mentioned angle, the upper surface of the inner insertion groove 11a is formed to have a slope angle of −2°, so the left and right distortions are performed closer to the biological articulation.

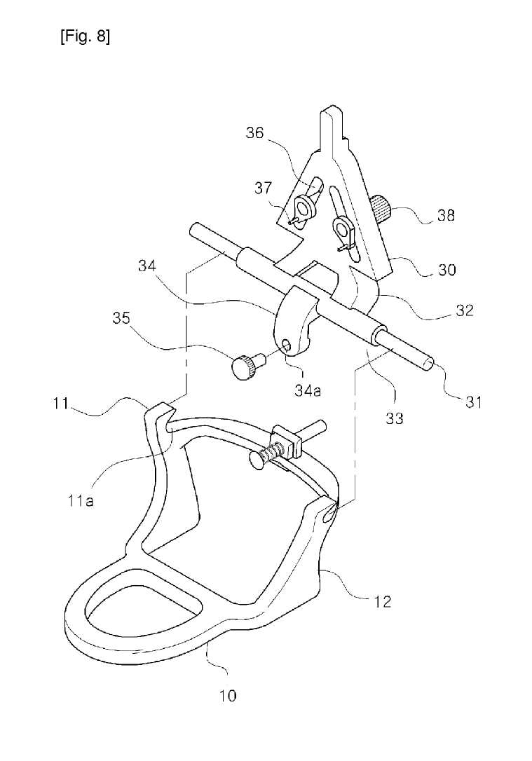

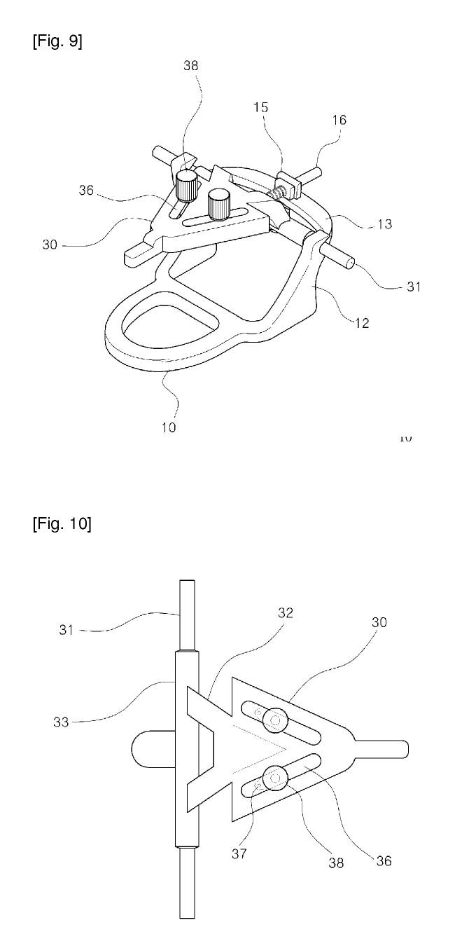

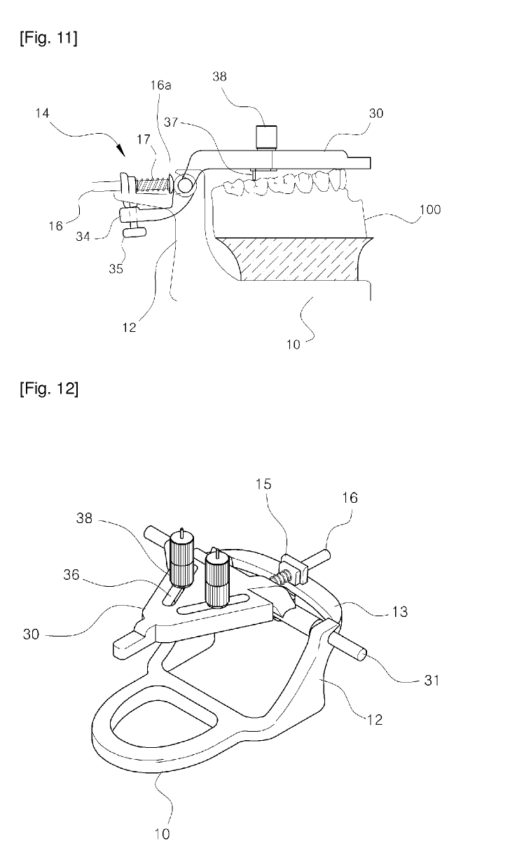

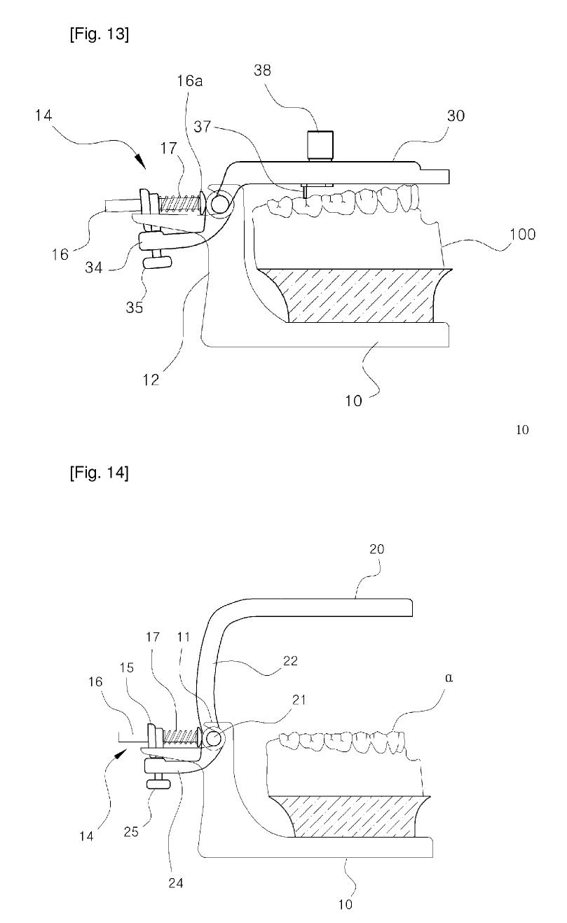

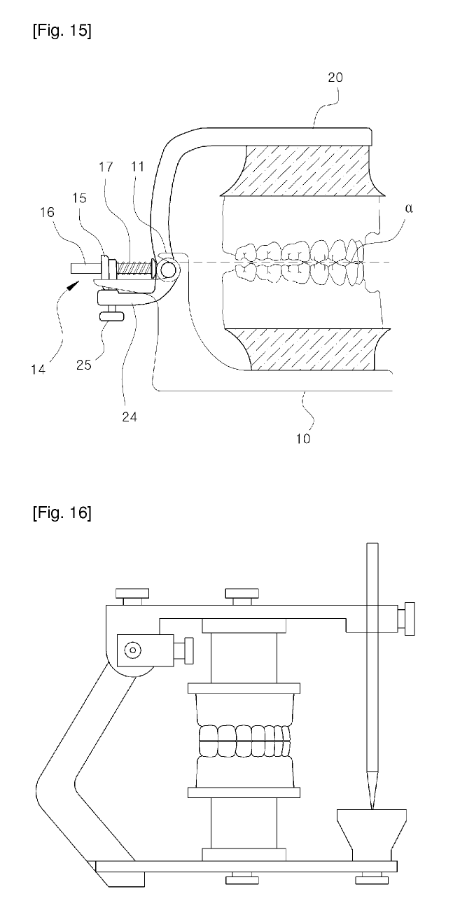

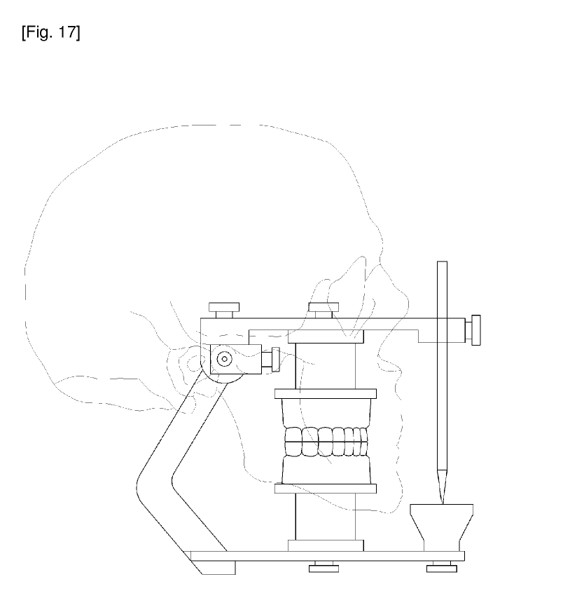

The work procedure of the above mentioned articulator will be described. The lower jaw model 100 is positioned on the top of the lower jaw mounting plate 10, and it is mounted using a plaster, and afterward the upper jaw model 200 is positioned at the lower side of the upper jaw mounting plate 20, and it is mounted using a plaster, and the lower jaw mounting plate 10 and the upper jaw mounting plate 20 are folded, and the coupled state is checked. At this time, when the lower jaw model 100 is positioned like FIGS. 8 and 9, it can be positioned in place on the articulating plane surface using the jig 30, and it is preferable that the detaching structure of the jig 30 is the same as the engaging structure of the upper jaw mounting plate 20.

The jig 30 is configured to be folded upward and downward as the shaft 33 is formed at the lower side of the column 32 formed at a rear side, and the rotary shaft 31 is protruded from both sides, and the lower jaw mounting plate 10 is axially engaged to the inner insertion groove 11a. At this time, the jig 30 is forwardly pressurized in a state that the rotary shaft 31 is engaged to the engaging part 11 by means of the support means formed at the lower jaw mounting plate 10, thus maintaining an axial engagement state.

Thanks to the above described assembling structure, on the contrary, when disconnecting the jig 30, the jig 30 is pulled backward and is disconnected by one touch method.

As the jig 30 is engaged at the lower jaw mounting plate 10, the articulating plane surface (α) of the lower jaw model 100 can be set, so the lower jaw model 100 can be easily made close to the lower side of the jig 30 for thereby fixing the position. Since the lower surface itself of the jig 30 functions as the articulating plane surface (α), a separate means such as an eye measurement, a rubber string, a laser, etc. is not needed. Since the lower jaw model 100 can come into close contact with the lower side of the jig 30, it is possible to mount the lower jaw model 100 at the accurate position of the articulating plane surface (α).

In addition, the jig 30 defines a rectangular slot groove 36, and when the molar positioning pin 37 and the adjusting pin 38 are mounted in the slot groove 36, the positions of the molar positioning pin 37 can be moved forward or backward by tightening or loosening the adjusting handle 38, so the engaged state of the lower jaw model 100 can be fixed.

As shown in FIG. 12, the adjusting handle 38 is formed in a two-tier structure, so the upper and lower height can be adjusted as the handle of the upper side allows the molar positioning pin 37 to ascend or descend, and the lower jaw model 100 can move to a certain position as the handle of the lower side adjusts forward and backward the molar positioning pin 37.

In this case, a rack gear is formed in the slot groove 36 in order for the rack gear and the handle of the lower side to engaged and cooperate, thus accurately adjusting the molar positioning pin 38.

As a backwardly prolonged hook protrusion 34 is formed at the shaft 33 of the jig 30, the upper surface of the hook protrusion 34 is caught on the lower surface of the suspension part 13, thus limiting the slope of the jig 30. At this time, a screw hole 34a is formed at the hook protrusion 34, and when the bolt 35 is tightened, the spaced apart space between the suspension part 13 and the hook protrusion 34 can be adjusted, so the limiting angle of the jig 30 can be accurately adjusted.

1. An articulator, comprising:
a lower jaw mounting plate 10 configured to mount a lower jaw model 100; an upper jaw mounting plate 20 configured to mount an upper jaw model 200; and
an engaging part 11 and a rotary shaft 21 which are formed at the lower jaw mounting plate 10 and the upper jaw mounting plate 20, respectively, and are axially engaged, and columns 12 and 22 formed at the rear sides of the lower jaw mounting plate 10 and the upper jaw mounting plate 20 have the same vertical heights, and as the rotary shaft 21 is positioned on an extended line of the articulating plane surface (α), so the lower jaw mounting plate 10 and the upper jaw mounting plate 20 are symmetrically positioned upward and downward about the rotary shaft 21, and when the upper jaw model 200 and the lower jaw mode 100 are folded upward and downward, the tangent line (β) of the rotational motion is vertically applied to the articulating plane surface.

2. An articulator according to claim 1, wherein the engaging part 11 has a laid-down channel shaped inner insertion groove 11a which is open via its rear side, and the rotary shaft 21 is protruded from both sides of the shaft 23 formed at the lower side of the column 22, and the upper jaw mounting plate 20 is axially engaged at a rear side of the shaft 23, and a support means 14 elastic with respect to the suspension part 13 connecting the upper sides of the columns 12 of the left and right sides of the upper jaw mounting plate 10 is provided, so the rear side of the shaft 23 is pressurized, and the axial engagement state of the lower jaw mounting plate 10 and the upper jaw mounting plate 20 is fixed.

3. An articulator according to claim 2, wherein the support means 14 is engaged in such a way that a pusher 16 can be inserted into a through hole 15a of a protrusion wall 15 as the protrusion wall 15 is upwardly protruded from the upper surface of the suspension part 13, and a compression spring 17 is disposed between the head 16a of the pusher 16 and the protrusion wall 15, thus pressurizing forward the pusher 16, and the detachable engagement of the lower jaw mounting plate 10 and the upper jaw mounting plate 20 can be made possible.

4. An articulator according to claim 2, wherein the engaging part 11 has a slope angle in such a way that the slope of the inner insertion groove 11a is backward sagged at an angle of −2°, and in case of the leftward and rightward distortions of the upper jaw mounting plate 20, they move closer to the biological articulation of teeth, so the articulating measurement can be more accurately performed.

5. An articulator according to claim 1, wherein the lower jaw mounting plate 10 is characterized in that a jig 30 is detachably engaged at the engaging part 11 so as to adjust the horizontal state of the lower jaw model 100, and the engaging part 11 has a laid-down channel shaped inner insertion groove 11a which is open to its rear side, and the rotary shaft 31 of the jig 30 is axially engaged to the rear side of the engaging part 11, so the jig 30 is detachably engaged to the lower jaw mounting plate 10 in one touch method.

6. An articulator according to claim 5, wherein the jig 30 has a rectangular slot hole 36, and the molar positioning pin 37 is engaged in the slot hole, and the position of the molar positioning pin 37 can be adjusted by the operation of the adjusting handle 38, so the lower jaw model can be fixed by pressurizing the upper surface of the molar in such a way to tighten the molar positioning pin 37.

7. An articulator according to claim 6, wherein the adjusting handle 38 is formed in a two-tier structure, and the position of the molar positioning pin 38 can be fixed as it ascends and descends upward and downward while transferring it forward and backward.

8. An articulator according to claim 5, wherein the rotary shaft 31 is protruded from both the left and right sides of the shaft 33 formed at the lower side of the column 32, and the shaft 33 has a hook protrusion 34 which is prolonged backward, thus supporting the lower side of the suspension part 13, and the hook protrusion 34 has a screw hole 34a, so the angle of the jig 30 can be adjusted by setting the upper and lower height of the hook protrusion 34 is adjusted as the bolt 35 is tightened.
